(19) United States
(12) Patent Application Publication
(10) Pub. No.: US 2006/0114700 A1
(43) Pub. Date: Jun. 1, 2006

(54) Method for controlling the transient response of a power converter powering a load, transient response controller and power converter

(76) Inventors: Thomas Durbaum, Langerwehe (DE); Franciscus Adrianus Schoofs, Valkenswaard (NL); Reinhold Elferich, Aachen (DE); Tobias Georg Tolle, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/521,850

(22) PCT Filed: Jul. 21, 2003
(86) PCT No.: PCT/IB03/02891

§ 371 Date: Sep. 29, 2005

(30) Foreign Application Priority Data
Jul. 26, 2002 (EP) 02016704.5

(51) Int. Cl. H02H 7/10

(52) U.S. Cl. 363/50

(57) ABSTRACT

A method for controlling the transient response of a power converter powering a load, said power converter comprising a power switch, a synchronous rectifier and a capacitor coupled between an input and an output of the power converter, said method comprising the step of—disabling said synchronous rectifier in response to a signal indicative of a change of said load, is characterized by—providing said signal based on a current representing said change of load.

The invention relates to a method for controlling the transient response of a power converter powering a load, said power converter comprising a power switch, a synchronous rectifier and a capacitor coupled between an input and an output of the power converter, said method comprising the step of disabling said synchronous rectifier in response to a signal indicative of a change of said load. The invention also relates to a transient response controller to perform the above method and to a power converter including such a transient response controller.

Power converters are subject to transient conditions, such as turn-on and turn-off transients, as well as sudden changes in load and input voltage. Future generations of high-speed digital integrated circuits such as high-performance processors, digital signal processors, system on chip, etc., will operate at lower voltages with tighter tolerances and increased dynamic load characteristics. These integrated circuits are able to reduce their power consumption from maximum to minimum within a few nanoseconds. This time period is much too short for the power supply to react. The supplied integrated circuit, after a turn-off transient, requires only a small amount of current. Thus, the energy stored in the buck coil charges the output capacitors, leading to a higher supply voltage. Since tolerances in the supply voltage are very small, the capacitance at the output has to be chosen in order to limit voltage excursion within this tolerance band. Consequently, many capacitors are needed to fulfill the requirement, which is cost intensive. Power converters therefore need new concepts.

Generally, a power converter comprises a power switch and a synchronous rectifier coupled between an input and an output of the power converter. Power switch and synchronous rectifier alternate between a conductive and a non-conductive state. When the power switch conducts, the synchronous rectifier is non-conductive and vice versa. A transient condition occurs, as shown in FIG. 1, at a time instant t=0, when the load is removed. The output current suddenly drops to zero and the converter output voltage rises above its nominal, steady-state value. The power switch is shut down and the synchronous rectifier remains in a conductive state. As a result, the converter output voltage rises to an undesirable level. Likewise, during this time, the output inductor current I_{L} drops at a rate roughly proportional to the output voltage divided by the inductance. The synchronous rectifier current drops at the same rate.

Normally, the synchronous rectifier is embodied by a MOSFET, which always includes a back-gate diode or body diode. The power converter disclosed in U.S. Pat. No. 5,940,287 A controls the synchronous rectifier by sensing that the power switch has been in a non-conductive state for a given time period and after lapse of that time period shutting down the synchronous rectifier, thus forcing conduction of the synchronous rectifier's body diode and thereby limiting the converter output voltage. Due to the increased voltage drop across the body diode part of the energy previously stored in the buck coil is now dissipated in the body diode, thus leaving less energy to be discharged into the output capacitor. Since the information about the change of load is taken from the gate signal of the MOSFET, an RC-time constant is involved, which is longer than one complete switching period. Therefore, while reduced, the voltage overshoot is still larger than necessary.

It is the object of the invention to provide a method for controlling the transient response of a power converter as defined in the introduction which can minimize output voltage overshoot reliably and very quickly.

In a first aspect of the invention, the object is solved in a method as defined above by providing said current-based signal representing said change of load to cause said transient response controller to immediately disable said synchronous rectifier without any time delay. This implementation is based on the principle of detecting a voltage rise across the capacitor and to counteract thereto by a suitable correcting measure. In a turn-off case, this correcting measure consists in shutting off not only the power switch but also the synchronous rectifier, so that the buck coil current is dissipated through the body diode effecting the desired additional voltage drop, as is already disclosed in U.S. Pat. No. 5,940,287. However, as seen from U.S. Pat. No. 5,940,287, a quick and accurate detection of a voltage change is less practicable due to the distractions to be expected and, therefore, one must wait until a measurable voltage rise occurs through charging the capacitor the voltage rise of which is furthermore indirectly exploited by waiting for a non-occurrence of the switching signal for the power switch. In contrast, the invention makes use of a current measurement, either directly or indirectly, so that a measure to counteract a decrease in the load can be initiated as early as possible.

Said current-based signal can be directly provided by said load. For example, when an integrated circuit or a microprocessor changes from an active into a passive state, it can itself communicate this information about a change of power consumption and therefore needed load current to the transient response controller which will then immediately shut off the synchronous rectifier's MOSFET. Generally, a controller associated with the load will know in advance about power consumption and therefore currents within the load, so that shut-off periods of the synchronous rectifier can be finely tuned and adapted not only to changes from the operational mode to the standby mode and vice versa, but also to specific operations occurring during the operational mode. The fine-tuning process can be implemented by comparing the current through the load or the current to be expected through the load with at least one threshold value and using this information to derive the shut off periods.

Another aspect of the invention uses the possibility to measure the current Iₒ through the load, which, however, is not easy to achieve due to the physical implementation of the microprocessor supply. Basically, in the case of a turn-off transient, a decrease of the current through the load must be detected. Since rapid recognition is required, a current through the buck coil may be regarded as constant. Therefore, the following approximation is correct:

$$\frac{ⅆ {I}_{c}}{ⅆ t} = - \frac{ⅆ {I}_{o}}{ⅆ t} , \qquad ( 1 )$$

wherein I_{c} is the current through the output capacitor which consequently can be used equally. The output capacitor regularly is not a single element, but consists of a plurality of parallel-connected capacitors which are each characterized by parasitic serial resistance R_{C} and serial inductance L_{C}. The time constant L_{C}/R_{C} however, is independent of the number of capacitors and is in the range of hundreds of nanoseconds. Now, the voltage of one of these capacitors can be measured. If this measured voltage is filtered by a first R₁C₁ element satisfying

$${C}_{1} {R}_{1} = \frac{{L}_{C}}{{R}_{C}} \qquad ( 2 )$$

wherein

R_{C}=parasitic serial resistance of capacitor element

L_{C}=parasitic serial inductance of capacitor element

C₁=capacitance of first RC element

R₁=resistance of first RC element,

a signal is obtained comprising a portion which is nearly constant for the time of the load transient, namely the voltage drop across the ideal capacitor C, and a portion proportional to the current, i.e. the voltage drop across serial resistance R_{C}. The condition in (2) compensates for the voltage drop across serial inductance L_{C}.

A preferred embodiment undercompensates the voltage drop across the serial inductance L_{C} by requiring

$${C}_{1} {R}_{1} < \frac{{L}_{C}}{{R}_{C}} \qquad ( 3 )$$

thus emphasizing a portion proportional to the change of current.

It is the advantage of the previous embodiments that said first filter stage shows low pass characteristics which is favorable with respect to interference susceptibility.

As before, the method can be finely tuned by comparing the current or signal with at least one threshold value.

The object is also solved by a transient response controller to be used in a power converter powering a load, said power converter comprising a power switch, a synchronous rectifier and a capacitor coupled between an input and an output thereof, said transient response controller being coupled at least to said synchronous rectifier and disabling said synchronous rectifier in response to a signal indicative of a change of said load, characterized in that said transient response controller is coupled to means for providing said signal based on a current representing said change of load.

Finally, the object is solved by a power converter powering a load which includes the transient response controller defined above. Said means for providing said signal comprises means for detecting the current through said load or means for detecting the voltage drop across said capacitor as well as means for comparing said current or voltage drop with at least one threshold value.

It is preferable that said means for providing said signal is a controller of said load communicating the power consumption of said load to said transient response controller.

Such a power converter can be used for powering high speed integrated circuits.

In the following, the invention will be described in further detail with reference to the accompanying drawing, wherein

FIG. 1 illustrates timing diagrams for a power converter without transient response control during a turn off transient;

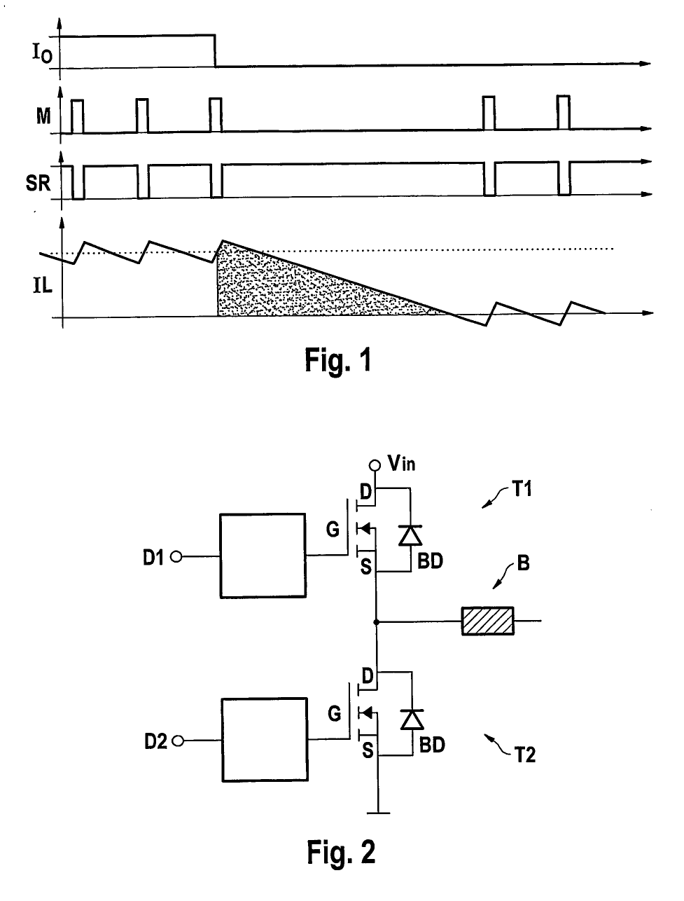

FIG. 2 illustrates a schematic diagram of a half bridge of a power converter;

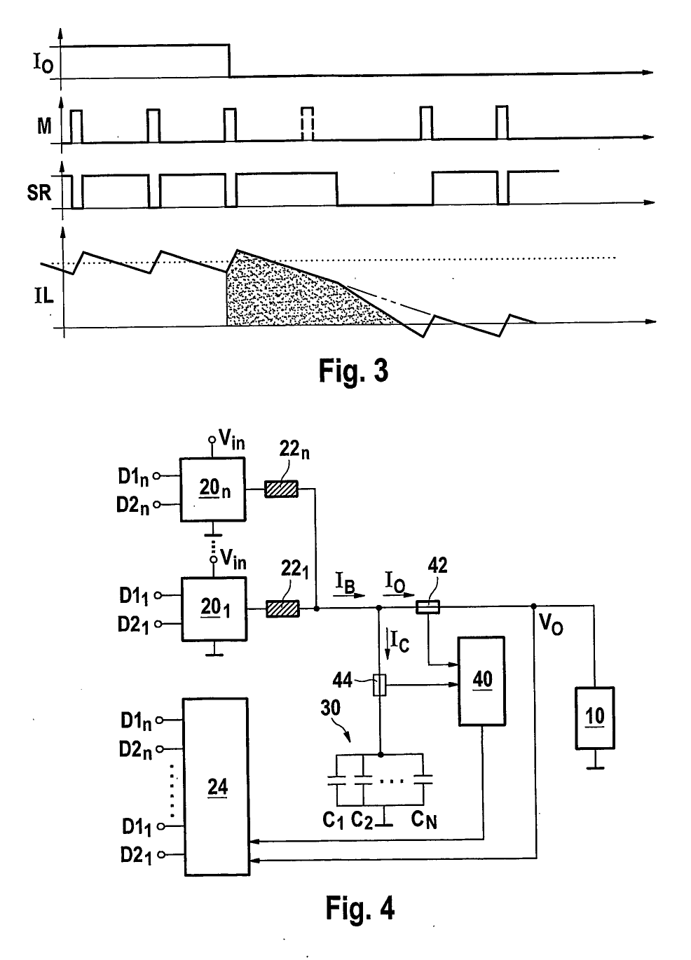

FIG. 3 illustrates timing diagrams for a power converter of the prior art during a turn off transient;

FIG. 4 illustrates a schematic diagram of a power converter embodying the present invention;

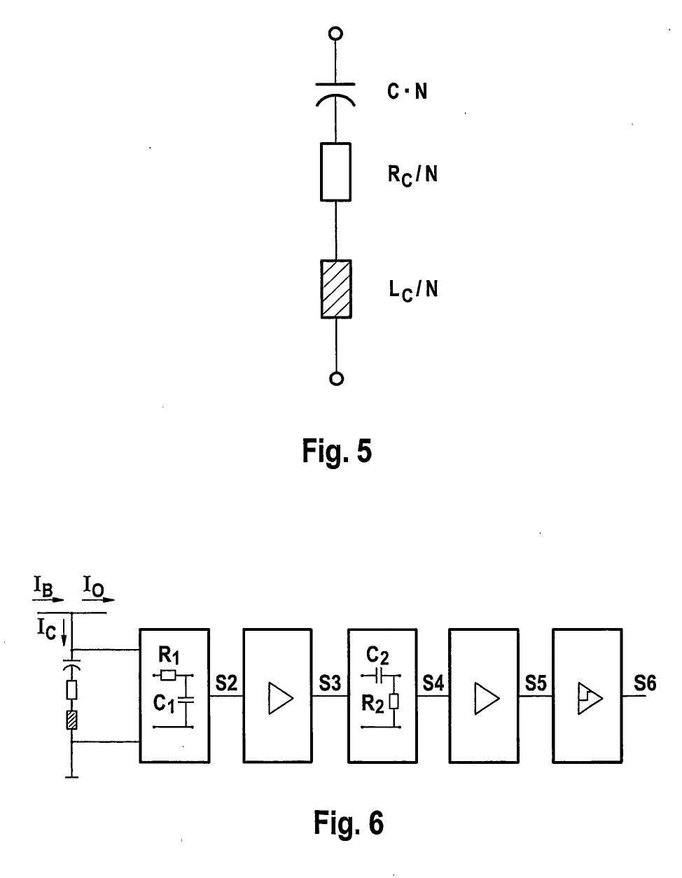

FIG. 5 shows an equivalent circuit diagram of the output capacitor;

FIG. 6 illustrates a preferred embodiment of the method for controlling the transient response of a power converter according to the invention; and

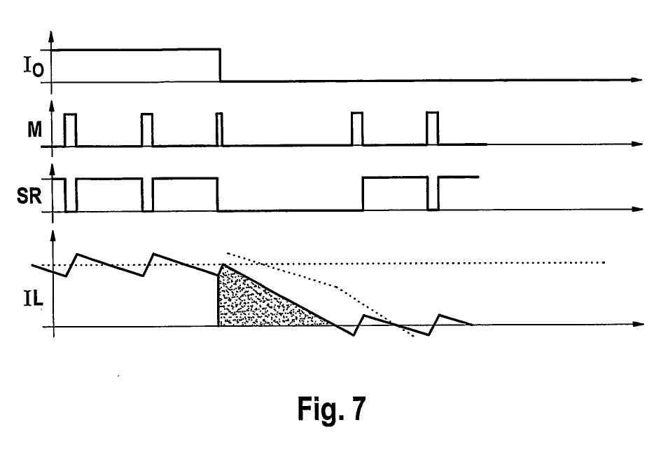

FIG. 7 illustrates timing diagrams for a synchronous rectifier controlling scheme according to the invention.

Referring initially to FIG. 1, exemplary current waveforms are illustrated for a power converter which has no special transient synchronous rectifier control. The wave form referenced by Iₒ represents the converter output current Iₒ, “M” represents the state of the power switch when in either a conducting or non-conducting state, “SR” represents the state of the synchronous rectifier when it is in either a conducting or non-conducting state, and “IL” represents the output inductor current I_{L} over the time period observed. As can be seen from FIG. 1, the power switch and synchronous rectifier alternate between a conductive and a non-conductive state such that when the power switch conducts the synchronous rectifier is non-conductive and vice versa. During normal operation, the converter output voltage and the current through the output inductor remain constant within certain limitations. When the output current Iₒ suddenly drops to zero, the normal power converter cannot reduce the value I_{L} quickly enough. The charge represented by the black area charges the output capacitor leading to a voltage overshoot.

FIG. 2 is a schematic diagram of a half bridge which is provided to illustrate the controlling scheme of the prior art. A power switch T1 and a synchronous rectifier T2 are both embodied by a MOSFET, wherein the gate G of each MOSFET is controlled by a respective driver D1 and D2. A buck coil B stores energy as described above. If an transient condition is detected, the control scheme of U.S. Pat. No. 5,940,287 shuts down not only the power switch T1, but also, after the power switch T1 has been in a non-conductive state for a given time period, synchronous rectifier T2. Bypassing the current to the intrinsic body diode BD of the MOSFET will dissipate part of the energy stored in the buck coil.

According to the control scheme of U.S. Pat. No. 5,940,287 and as illustrated in FIG. 3, the controller has to wait at least until the next timing signal would occur at the power switch before shutting down the synchronous rectifier. Conduction through the body diode is then forced which limits the converter output voltage Vₒ.

FIG. 4 illustrates a schematic diagram of a power converter embodying the present invention. The power converter comprises half bridges 20₁ to 20ₙ, each of them having a similar construction than those shown in FIG. 2 with their respective buck coil 22₁ to 22ₙ. Signals from a controller 24 are given to inputs D1₁, D2₁ to D1ₙ, D2ₙ to control the circuitry within half bridges 20₁ to 20ₙ. An output capacitor 30 consisting of parallel connected capacitor elements C₁, C₂ to C_{N}, is coupled to the output of the power converter. The converter output voltage V₀ is measured across capacitor 30. Further, a load 10 is coupled across the output capacitor 30. Current I_{B} from the buck coils 22₁ to 22ₙ branches into current Iₒ through load 10 and current I_{C} to capacitor 30. Boxes 42, 44 symbolize the detection of either current Iₒ or current I_{C}.

A possible embodiment of the control scheme of the present invention will be explained with respect to changes of current I_{C} through capacitor 30, provided that in case of equal capacitances an equivalent circuit diagram applies as shown in FIG. 5.

The resulting overshoot is lower since the charge indicated by the black area in FIG. 7 is lower than in the previous methods.

FIG. 6 shows that the voltage across the capacitor is tapped and filtered by a first RC element with a resistance R₁ and capacitance C₁ to satisfy equation (2) above. The resulting signal S2 includes a component proportional to the current I_{C}, as explained above with respect to equation (2). Optional, an impedance converter can be provided to output signal S3 which is input into a high pass filter or second RC element, wherein capacitance C₂ and resistance R₂ thereof are selected to satisfy
C₂R₂>>C₁R₁ (4)

to filter the constant component from the signal. The resulting signal S4 is then amplified and; amplified signal S5 is given into a comparator which detects whether or not signal S5 exceeds a predetermined threshold value. If a threshold value is exceeded, signal S6 is changed from low to high. The high signal is then given to controller 24 to shut off of both power switch T1 and synchronous rectifier T2. In a further improved embodiment the comparator will have two or more threshold values to signal to controller 24 that a smaller or larger current rise is occurring which leads to a respective smaller or larger voltage rise. Thus, controller 24 is enabled to set either synchronizing as usual or bypassing the body diode, as the case will be.

Additionally, threshold values representing negative currents can be predetermined to effect the termination of the body diode conduction mode early enough to ensure that power converter operation is not distracted.

FIG. 7 shows the timing diagram wherein drop of the current I_{L} sets on immediately, so that voltage overshoot can be minimized. In “IL” of FIG. 7, the comparison with the graphs of FIGS. 1 and 3 are shown in dotted lines. As can be seen in the Figures, the effect is dramatically positive with decreasingly required supply voltage.

1. A method for controlling the transient response of a power converter powering a load (10), said power converter comprising a power switch (T1), a synchronous rectifier (T2) and a capacitor (30; C₁, C₂, . . . C_{N}) coupled between an input and an output of the power converter, said method comprising the step of
disabling said synchronous rectifier (T2) in response to a signal indicative of a change of said load (10),
characterized by
providing said signal based on a current representing said change of load.

2. The method as claimed in claim 1,
characterized in that said load (10) communicates information about its needed current to provide said signal.

3. The method as claimed in claim 1,
characterized in that said signal is provided by detecting a current (Iₒ) through said load (10).

4. The method as claimed in claim 1,
characterized in that said signal is provided by detecting a current (I_{C}).

5. A method for detecting the transient response of a power converter powering a load (10), characterized by
filtering a voltage across said capacitor (30) by a first RC element, said first RC element satisfying
$${C}_{1} {R}_{1} \leq \frac{{L}_{C}}{{R}_{C}}$$
wherein
R_{C}=parasitic serial resistance of capacitor
L_{C}=parasitic serial inductance of capacitor
R₁=resistance of first RC element
C₁=capacitance of first RC element

6. The method as claimed in any of claims 1 to 5,
characterized that said signal based on a current is compared to at least one threshold value.

7. Transient response controller to be used in a power converter powering a load (10), said power converter comprising a power switch (T1), a synchronous rectifier (T2) and a capacitor (30; C₁, C₂ . . . C_{N}) coupled between an input and an output thereof, said transient response controller being coupled at least to said synchronous rectifier (T2) to disable said synchronous rectifier in response to a signal indicative of a change of said load (10),
characterized in that said transient response controller (40) is coupled to means for providing said signal based on a current representing the change of load.

8. A power converter powering a load, comprising a power switch (T1), a synchronous rectifier (T2) and a capacitor (30; C₁, C₂ . . . C_{N}) coupled between an input and an output of the power converter, and a transient response controller (40) coupled to at least said synchronous rectifier T2, said transient response controller (40) disabling said synchronous rectifier in response to a signal indicative of a change of said load (10), by means for providing said signal based on a current representing said change of load, said means for providing said signal being coupled to said transient response controller (40).

9. The power converter as claimed in claim 8,
characterized in that said means for providing said signal is a controller of said load (10) communicating the power consumption of said load (10) to said transient response controller (40).

10. The power converter as claimed in claim 8,
characterized in that said means for providing said signal comprises means for detecting the current through said load (10) and means for comparing said current (Iₒ) with at least one threshold value.

11. The power converter as claimed in claim 8,
characterized in that said means for providing said signal comprises means for detecting the current (I_{C}) through said capacitor (30) by a voltage drop across said capacitor (30) and means for comparing said voltage drop with at least one threshold value.

12. The power converter as claimed in any of claims 8 to 11,
characterized in that said transient response controller (40) is connected to said power switch (T1) to switch off said power switch in response to said signal.

13. Use of power converter as claimed in any of claims 8 to 12 for powering high speed integrated circuits.
